(19) United States
(12) Patent Application Publication
(10) Pub. No.: US 2009/0202768 A1
(43) Pub. Date: Aug. 13, 2009

(54) USE OF POLYAMIDE 11 FOR THE INTERNAL COATING OF A GAS PIPELINE TO REDUCE PRESSURE LOSS

(76) Inventors: Yves Charron, Longpont-sur-Orge (FR); Valerie Sauvant-Moynot, Lyon (FR); Sebastien Duval, Evron (FR); Jean Kittel, Lyon (FR); Didier Aguillaume, Charly (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/091,542

(22) PCT Filed: Oct. 19, 2006
(86) PCT No.: PCT/FR2006/002368

§ 371 Date: Oct. 2, 2008

(30) Foreign Application Priority Data
Oct. 27, 2005 (FR) 0511127

(51) Int. Cl. B32B 1/08; C08G 69/08

(52) U.S. Cl. 428/36.91; 528/310

(57) ABSTRACT

The invention relates to the use of polyamide 11 as an internal coating for a gas transport pipeline to reduce pressure loss.

The invention relates to the field of internal gas pipeline coatings. The purpose of this invention is to allow a reduction of pressure loss in the transport of gas by the pipeline, in particular to limit compression infrastructures, or to make it possible to reduce the internal diameter of pipelines.

Thus, the invention proposes the use of polyamide 11 as internal coating of a gas transport pipeline to reduce pressure loss.

According to the invention, polyamide can be applied in powder form in the pipeline before being heated.

In a variation according to the invention, the thickness of the coating can be between 20 and 400 μm.

The invention will be better understood and its advantages will appear more clearly by reading the following tests, in no way limiting, illustrated by the following attached figures, including:

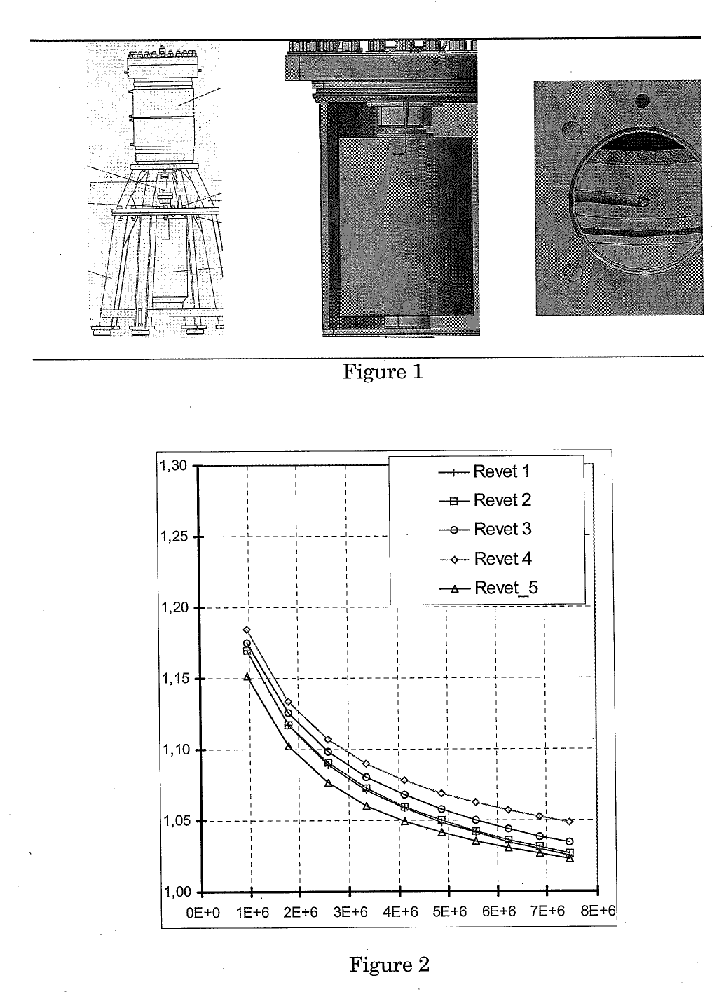

FIG. 1 shows schematically the test device;

FIG. 2 gives the friction parameter as a function of the Reynolds number for five different coatings,

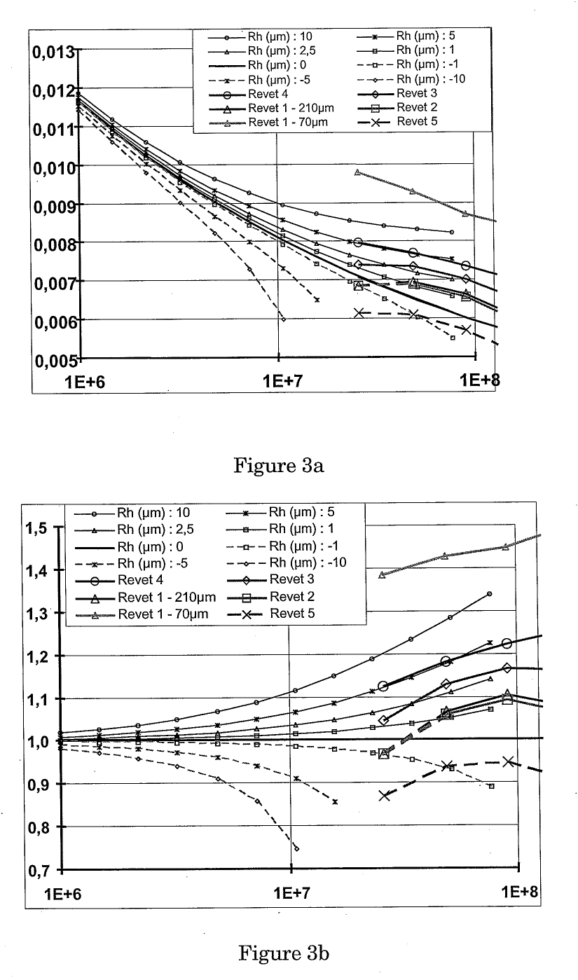

FIG. 3a gives the friction factor as a function of the Reynolds number for a 1 meter tube and for coatings type 1-5. The small and large symbols correspond, respectively, to the steel and to the coatings,

FIG. 3b give the spread of the friction factor as a function of the Reynolds number compared to a 1 meter steel head and for coatings type 1-5. The same symbols are the ones used for FIG. 3a,

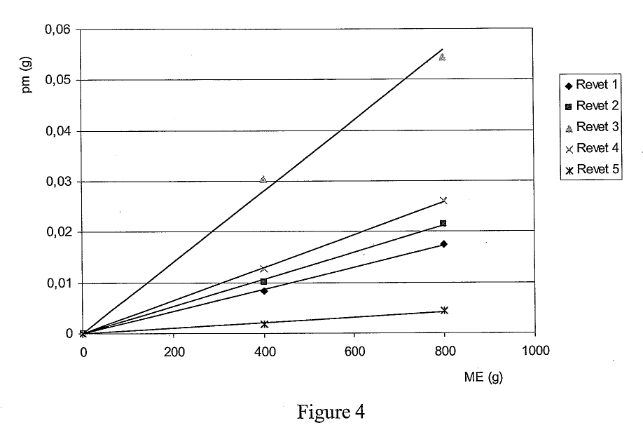

FIG. 4 gives the erosion in loss of mass (lm) as a function of erodent mass (EM) for five different coatings.

The Testing Apparatus:

The testing apparatus will be called “turning device.” U.S. Pat. No. 6,260,413 describes an apparatus very similar to the one used below.

It has the following operating principle: a cylinder (the rotor) mounted in a housing is mechanically rotated by an electrical motor. The rotation of the rotor carries in its movement a gas present in the housing on the exterior of this cylinder. The gas is braked in its movement by an external fixed cylinder (the jacket). The braking of the gas and, consequently, of the rotor depends on the roughness of the walls of the two cylinders (fixed and rotor), the rotation speed of the rotor and the properties of the gas. The system was designed to measure the aerodynamic characteristics of the internal wall of an interchangeable jacket, the rotor being unchanged during the different jacket tests.

The aerodynamic characteristics of a jacket are measured by both a torque meter mounted on the rotor shaft, between the rotor and the electric motor, and on the Pitot tube mounted at an equal distance between the external wall of the jacket, the Pitot tube was placed in the opposite direction of the rotor motion.

FIG. 1 illustrates: from left to right: an overview of the turning device, an internal view of the device mounting the rotor, the jacket and a Pitot tube, cover),—and a top view of the Pitot tube.

The gases used are nitrogen and argon. The gas pressure varies during the test between 10 and 100 bar, and the rotation speed of the rotor varies between 1500 and 3000 RPM for argon. These test conditions permit us to obtain the viscous layer between several tenths to several microns and, consequently, to measure the hydraulic roughness of the same order of magnitude.

Treatment of the Measures Relating to the Pitot Tube:

The peripheral speed U of the rotor is calculated using the rotation speed of the rotor and its diameter.

The Pitot tube supplies the dynamic pressure at the measuring point. Knowing the density gives the gas velocity relative to the fixed wall, U2. Consequently, the velocity of the gas relative to the movable wall is U1=U−U2.

The performance of a test jacket is established compared to reference jackets which are stainless steel jackets, whose interior was sand-blasted. The roughness range runs from 0.3 to 7 microns Ra (4 to 55 microns Ry5) for all of the jackets. Ra and Ry5 are roughness measures defined by standard ISO 4287: Ra represents the average and Ry5 the average of 5 intervals of the deviation between the highest and weakest amplitude points.

The performance of the reference jackets as the testing jackets was established by analyzing parameter U1/U2 as a function of the Reynolds number (Re) of the channel separating the internal and external cylinders. It was observed that for all of the jackets tested, the curve representing U1/U2 as a function of Re is the same regardless of conditions of temperature, pressure, gas quality and rotor rotation speed. The change in U1/U2 as a function of Re is therefore distinct for each type of jacket.

Knowing the U1/U2 curves of the reference jackets makes it possible to determine the aerodynamic performance of a testing jacket either:
by interpolation, when the equivalent hydraulic roughness is above that of the jacket with the lowest roughness value (0.3 micrometers of Ra).
by extrapolation, when the equivalent hydraulic roughness is above that of the jacket with the last value.

The aerodynamic performance of a testing jacket is defined by its hydraulic roughness. Contrary to physical roughness, hydraulic roughness is dependent on the Reynolds number.

Types of Internal Coatings Tested and Principal Results Obtained:

The application of an internal coating in a gas pipeline aimed at significantly reducing the friction factor on the wall compared to a non-coated pipe. The pressure loss reduction effect is calculated as described in the previous paragraph.

The tested coatings comprise:
epoxy resin solvent-base coatings with organic solvent;
solvent free epoxy resin liquid coating;
A polyamide 11 powder coating—powder made to melt after being applied to the substrate following the procedures known by someone versed in the art;

It was observed during the tests that the equivalent hydraulic roughness of a coating:
Increases when its physical roughness increases. The physical roughness is obtained by filtering the waves of a wavelength higher than the one corresponding to the roughness (low-pass filter RC with filtration threshold or “cut-off” of 0.8 mm). The low-pass filter RC and the “cut-off” are known to someone versed in the art;
Increases when the ripple factor increases (orange peel effect). The physical roughness is obtained by filtering the waves of a wavelength higher than the one corresponding to the ripple (“cut-off” of 2.5 or 8 mm depending on the wavelength of the ripples to analyze);
is weaker for an epoxy resin, or for polyamide 11 than that of steel for equivalent physical roughnesses.

It was also observed that the equivalent physical roughness of a coating diminishes when the thickness of a coating increases to a value on the order of 150 to 200 micrometers which typically makes it smooth the roughness effects of the metal substrate, prepared in advance by sand-blasting following the standards of the trade. However, these parameter only impacts to the degree that an increase in thickness contributes to decrease the physical roughness and the rippling rate resulting from running, or the drying process. In the case of epoxy resins with thickness greater than 200 to 300 microns, hydraulic roughness tends to increase with thickness, most of all for solvent-base resins, taking into account the rippling rate resulting from seams, or from the drying process.

In short, the equivalent hydraulic roughness of a coating is primarily a function of the physical roughness, the rippling rate and the nature of the material or the components making up this material.

FIG. 2 gives the friction parameter U1/U2 (in sequence) as a function of the Reynolds number (Re) (in x-axis) for five different coatings: Coating_{—}1 through Coating_{—}5. The gas used is argon.

Polyamide 11 (Coating_5) was tested to compare with the epoxy coatings (Coating_{—}1 through _{—}4) specially optimized (thickness of the coatings: 150 to 200 micrometers). The results obtained were the average of a sampling of three coatings (Coating_{—}1, 2 and 5), four coatings (Coating_{—}3) and two coatings (Coating_{—}4). Coatings 1 to 3 are solvent-base, as against coating 4 which is without solvent.

It was observed that the friction parameter U1/U2 (or hydraulic roughness) of the polyamide 11 is lower than that of all of the coatings tested on this date as indicated in FIG. 2. The good performance of Polyamide 11 could, in particular, be the result of the very low value of physical roughness (Table 1 below—Cut-off of 0.8 mm) and the very low rippling rates (cut-off of 2.5 mm)

TABLE 1

| | Coating | Coating | Coating | Coating | Coating |
|---|---|---|---|---|---|
| | 1 | 2 | 3 | 4 | 5 |
| Ra μm-CO: | 1.2 | 1.3 | 1.2 | 1.2 | 0.14 |
| 0.8 mm | | | | | |
| Ry5 μm-CO: | 7.3 | 8.2 | 7.8 | 8.2 | 1.4 |
| 0.8 mm | | | | | |
| Ra μm-CO: | 1.9 | 2.2 | 1.8 | 3.2 | 0.4 |
| 2.5 mm | | | | | |
| Ry5 μm-CO: | 10.1 | 11.7 | 10.6 | 13.9 | 2.1 |
| 2.5 mm | | | | | |

On the basis of the interpolated and extrapolated hydraulic roughnesses, the fiction factor is calculated for a 1 meter tube, for Reynolds numbers greater than 2.10⁷ (FIG. 3a).

The friction factor is defined as a function of the pressure loss in the pipelines by:

DP=ƒρ LV²/D2g, where ƒ, ρ, L, D V are respectively, the friction factor, fluid density, the length and diameter of the pipeline and the fluid velocity.

The friction factor is calculated using the Colebrook & White equation [see original for formula], where the Reynolds Number is defined by Re=VDρ/μ, μ being the absolute viscosity of the fluid and Rh the absolute hydraulic roughness.

The friction factor of polyamide 11 was extrapolated in especially difficult extrapolation conditions taking into account its particularly negative hydraulic roughness. However, the friction factor of the polyamide 11 is significantly lower than that of the coatings 1 and 2 as indicated in FIG. 2.

At a Reynolds number on the order of 2. 10⁷, the polyamide 11 has a friction factor 5 to 10 weaker than the best epoxy coating tested and 15 to 20% weaker than the average of the epoxy coatings tested. The difference between the friction factors tends to increase when the Reynolds number increases.

Erosion

Erosion tests were conducted on coatings 1 through 5. FIG. 4 gives the mass loss results (pm in grams in sequence) obtained by corundum wear (mass in ME grams in erodent on x-axis) with a grading of about 450 μm, blown at a velocity of 20 m/s, at a 30° angle. These tests made it possible to rank the sensitivity of the coatings to wear/erosion according to their nature. Polyamide 11 demonstrated a wear/erosion resistance far superior to the other coatings tested.

The performance of films with polyamide 11 base is to align their semi-crystalline thermoplastic character which they give to polyamide coatings in general to a mechanical resistance increased thanks to the tendency to plastic deformation, unlike epoxy-base coatings derived from thermosetting polymers known for their fragile nature.

1. Use of polyamide 11 as internal coating of a gas pipeline to reduce pressure loss.

2. Use according to claim 1, whereby the polyamide is deposited in powdered form in the pipeline before being heated.

3. Use according to claim 1, whereby the thickness of the coating is between 20 and 400 μm.

4. A gas pipeline comprising a pipe and a polyamide 11 coating provided on an internal surface of the pipe to reduce pressure loss.

5. A gas pipeline according to claim 4, wherein the thickness of the polyamide 11 coating is between 20 and 400 μm.

6. A method for reducing pressure loss in a gas pipeline, comprising coating an internal surface of the gas pipeline with polyamide 11.

7. A method according to claim 6, wherein the polyamide 11 is deposited in powdered form in the gas pipeline and heated.

8. A method according to claim 6, wherein the thickness of the polyamide 11 is between 20 and 400 μm.
